(19) United States
(12) Patent Application Publication
(10) Pub. No.: US 2011/0153694 A1
(43) Pub. Date: Jun. 23, 2011

(54) Receiving device, data file recording method, and program

(75) Inventor: Tetsunori Nakayama, Tokyo (JP)

(73) Assignee: Sony Corporation, Tokyo (JP)

(21) Appl. No.: 12/925,855

(22) Filed: Nov. 1, 2010

(30) Foreign Application Priority Data
Dec. 21, 2009 (JP) P2009-289460

(51) Int. Cl. G06F 17/30

(52) U.S. Cl. 707/825; 707/E17.005

(57) ABSTRACT

A receiving device includes a communication unit receiving at least one data file from another device via a communication connection; and a control unit controlling recording of the data file received from the communication unit in a recording medium. The control unit creates one data recording folder for one communication connection in a predetermined reception folder provided in the recording medium and records, in the created data recording folder, the data file received via the communication connection corresponding to the data recording folder and a management file in which attribute information regarding each data file is stored.

### BACKGROUND OF THE INVENTION

1. Field of the Invention

The present invention relates to a receiving device, data file recording method, and program.

2. Description of the Related Art

In recent years, electronic devices capable of transferring content data, such as moving picture data or music data having a relatively large amount, to other electronic devices by using a short-range wireless communication technology typified by TransferJet® have been put into practical use. Also, with an increased amount and number of data files to be recorded in a recording medium, most of electronic devices, such as digital cameras or digital music players, allow these files to be hierarchically retained to facilitate an access to the files. For example, Japanese Unexamined Patent Application Publication No. 2009-033369 describes a folder configuration of a recording device forming a hierarchical structure as a whole, in which content data, attribute data of contents, playlist data, and others are stored in different folders.

### SUMMARY OF THE INVENTION

However, while the communication capacity or recording capacity of electronic devices has been dramatically increased, in order to reduce cost of the electronic devices, the processing speed of a processor provided in an electronic device may be relatively slow. If the processing speed of the processor is insufficient, when a data file is recorded under a complicated folder configuration, process cost for creating a folder and the like may disadvantageously decrease performance of the device as a whole. By contrast, if all data files are recorded without exception in a specific place without creating a new folder, data file management becomes difficult, although performance is improved.

In short-range wireless communication, it is desirable to provide a new and improved receiving device, data file recording method, and program capable of mitigating a decrease in performance at the time of transmission and reception of data files, while ease of data file management is kept at a predetermined level.

According to an embodiment of the present invention, a receiving device is provided including a communication unit receiving at least one data file from another device via a communication connection; and a control unit controlling recording of the data file received from the communication unit in a recording medium, the control unit creating one data recording folder for one communication connection in a predetermined reception folder provided in the recording medium, and recording, in the created data recording folder, the data file received via the communication connection corresponding to the data recording folder, and a management file in which attribute information regarding each data file is stored.

Also, the control unit may record the data file immediately below the data recording folder irrespectively of a file path of each data file before transfer.

Furthermore, the control unit may change a file name of each data file according to a predetermined rule, and then record each data file in the data recording folder.

Still further, the control unit may store, in the management file, a file path of each data file in the other device before transfer as the attribute information of the data file.

Still further, the control unit may output the management file together with the data file to a device in which the data file recorded in the data recording folder is to be arranged according to the file path before transfer.

Still further, the recording medium may be a recording medium having a predetermined restriction on a depth of a hierarchy of creatable folders.

Still further, the communication connection may be a communication connection established according to a short-range wireless communication technique.

Still further, according to another embodiment of the present invention, a data file recording method in a receiving device receiving at least one data file from another device via a communication connection is provided, the method including the steps of establishing the communication connection with the other device; creating one data recording folder for one communication connection in a predetermined reception folder provided in the recording medium; and recording, in the created data recording folder, the data file received via the communication connection corresponding to the data recording folder, and a management file in which attribute information regarding each data file is stored.

Still further, according to still another embodiment of the present invention, a program causing a computer controlling a receiving device receiving at least one data file from another device via a communication connection to function as a control unit controlling recording of the received data file in a recording medium is provided, the control unit creating one data recording folder for one communication connection in a predetermined reception folder provided in the recording medium, and recording, in the created data recording folder, the data file received via the communication connection corresponding to the data recording folder, and a management file in which attribute information regarding each data file is stored.

As described above, according to the receiving device, data file recording method, and program of the embodiments of the present invention, in short-range wireless communication, a decrease in performance at the time of transmission and reception of data files can be mitigated, while ease of data file management is kept at a predetermined level.

### BRIEF DESCRIPTION OF THE DRAWINGS

FIG. 1 conceptually illustrates a general outline of a short-range wireless communication system;

FIG. 2 further illustrates an example of a receiving device;

FIG. 3 illustrates a first technique in related art of an embodiment of the present invention;

FIG. 4 illustrates a second technique in related art of the embodiment of the present invention;

FIG. 5 is a block diagram of an example of configuration of the receiving device according to the embodiment of the present invention;

FIG. 6 illustrates an example of arrangement of received data files in the receiving device according to the embodiment of the present invention;

FIG. 7 illustrates an example of a management file recorded in the receiving device according to the embodiment of the present invention;

FIG. 8 is a flowchart of an example of a flow of a data file receiving process according to the embodiment of the present invention; and

FIG. 9 is a flowchart of another example of the flow of the data file receiving process according to the embodiment of the present invention.

### DESCRIPTION OF THE PREFERRED EMBODIMENTS

With reference to the attached drawings, preferred embodiments of the present invention are described in detail below. Here, in the specification and the drawings, components having substantially the same functions and structures are provided with the same reference characters, and are not redundantly described.

Description of the preferred embodiments is made according to the following sequence.

1. General Outline of a Short-Range Wireless Communication System
1-1. Description of the Devices
1-2. Problems in the Related Art

2. Example of the Configuration of a Receiving Device According to the Embodiment
2-1. Description of Each Component
2-2. Example of a Folder Configuration According to the Embodiment
2-3. Example of a Management File According to the Embodiment
2-4. Reconstruction of the Folder Configuration

3. Flow of Data File Receiving Process According to the Embodiment
3-1. First Scenario
3-2. Second Scenario

4. Conclusion

### 1. General Outline of a Short-Range Wireless Communication System

### 1-1. Description of the Devices

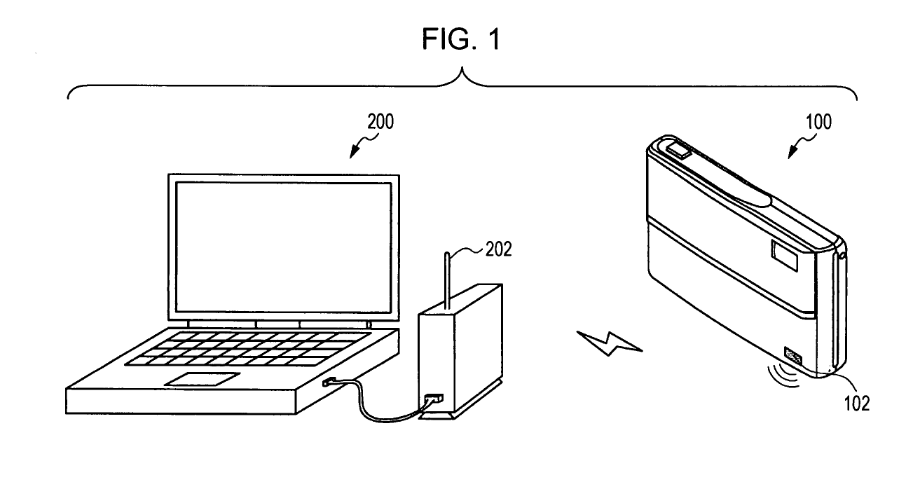

First, a general outline of a short-range wireless communication system applicable to an embodiment of the present invention is described by using FIG. 1. With reference to FIG. 1, a receiving device 100 and a transmitting device 200 configuring a short-range wireless communication system are depicted.

The receiving device 100 receives a data file transmitted from the transmitting device 200 via an antenna 102. On the other hand, the transmitting device 200 transmits via an antenna 202 a group of data files specified by a user to the receiving device 100. A communication connection between the receiving device 100 and the transmitting device 200 is established by using a short-range wireless communication technology, such as TransferJet® or near field communication (NFC). For example, when TransferJet® is used, a transfer rate of 560 Mbps at maximum can be achieved in a physical layer. Therefore, the user can transfer a group of data files that can include image data, music data, or video data from the transmitting device 200 to the receiving device 100 within a relatively short period of time even when the data size is large.

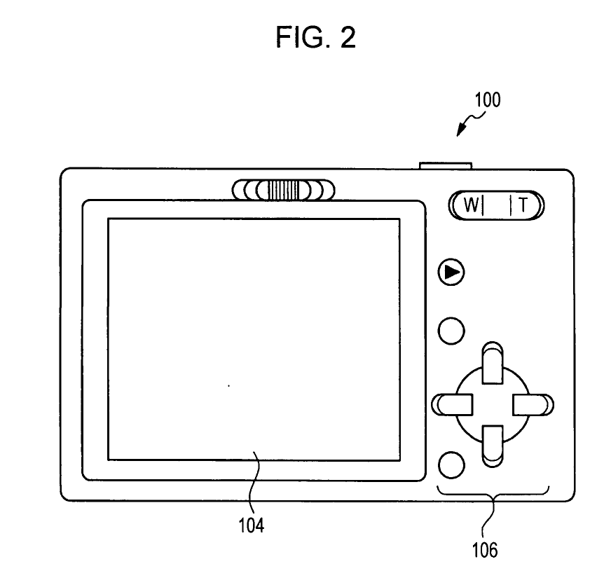

FIG. 2 further illustrates the receiving device 100. In an external view, the receiving device 100 includes, in addition to the antenna 102 depicted in FIG. 1, a display unit 104 and an operation unit 106. The display unit 104 is configured of, for example, a liquid crystal display (LCD) or an organic light-emitting diode (O-LED) display. The display unit 104 displays, for example, a list of data files recorded in a recording medium inside of the receiving device 100. The operation unit 106 is a part for the receiving device 100 to receive a user input. For example, the operation unit 106 may be a physical input unit, such as a button, a switch, a dial, or a lever. Alternatively, the operation unit 106 may be implemented as a graphical user interface (GUI) displayed on the display unit 104 having a touch panel function. Here, the transmitting device 200 depicted in FIG. 1 also has a similar display unit and a similar operation unit.

Here, the example has been described in which the receiving device 100 is a digital camera. However, the receiving device 100 is not restricted to this example, and may be, for example, a portable device, such as a mobile phone, a personal digital assistant (PDA), a digital music player, or a game terminal, or other types of information processing device. Also, the example has been described in which the transmitting device 200 is a personal computer (PC). However, the transmitting device 200 is not restricted to this example, either, and may be any type of device described above.

### 1-2. Problems in the Related Art

In the short-range wireless communication system described in the above section, when a group of data files is transmitted from the transmitting device 200 to the receiving device 100, the target group of data files is assumed to form a hierarchical folder configuration in the transmitting device 200. In this case, as technologies relating to the embodiment of the present invention, two techniques can be thought for receiving this group of data files. A first technique is a technique of recording in a recording medium on a reception side while the folder configuration of the group of data files is kept (that is, with a similar folder configuration). On the other hand, a second technique is a technique of disregarding the folder configuration of the group of data files and flatly recording all data files in a recording medium on a reception side.

### First Technique

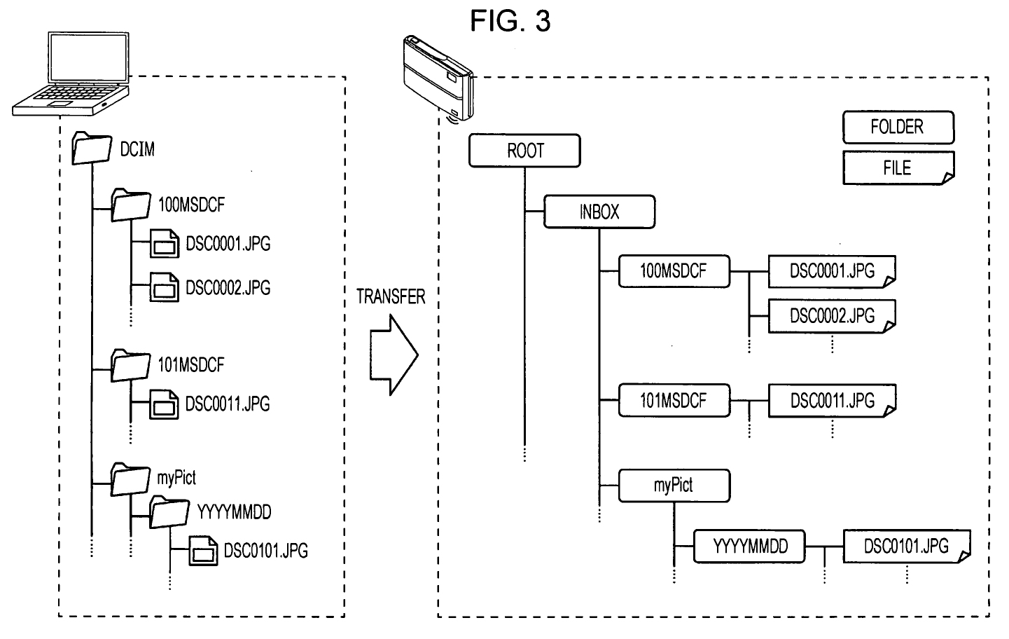

FIG. 3 illustrates the first technique for receiving a group of data files. On a left side of FIG. 3, a folder configuration of data files on a transmission side before data file transfer is depicted. For example, under a folder “DCIM”, three folders “100MSDCF”, “101MSDCF”, and “myPict” are present. Among these folders, in the folder “100MSDCF”, data files “DSC0001.JPG” and “DSC0002.JPG” are recorded. Also, in the folder “101MSDCF”, a data file “DSC0011.JPG” is recorded. Furthermore, in the folder “myPict”, a folder “YYYYMMDD” is present. In the folder “YYYYMMDD”, a data file “DSC0101.JPG” is recorded.

In the first technique, such a hierarchical folder configuration is kept also on a reception side. That is, in the recording medium on the reception side, for example, in a folder “INBOX” under a root, three folders “100MSDCF”, “101MSDCF”, and “myPict” are created. And, in the folder “100MSDCF”, data files “DSC0001.JPG” and “DSC0002.JPG” are recorded. Also, in the folder “101MSDCF”, a data file “DSC0011.JPG” is recorded. Furthermore, in the folder “myPict”, a folder “YYYYMMDD” is present. In the folder “YYYYMMDD”, a data file “DSC0101.JPG” is recorded.

A receiving process with the first technique may cause a decrease in performance on the reception side. For example, when a processor included in a small-sized device, such as a general digital camera, is used, it takes several tens to several hundreds of milliseconds to create one folder in the recording medium. Therefore, when the number of folders to be created increases, other processing suspends on the reception side by the amount of time proportional to the increased number of folders. Moreover, in a device with a restricted depth of a folder hierarchy that can be handled, a group of data files may not be recorded with their folder configuration maintained.

### Second Technique

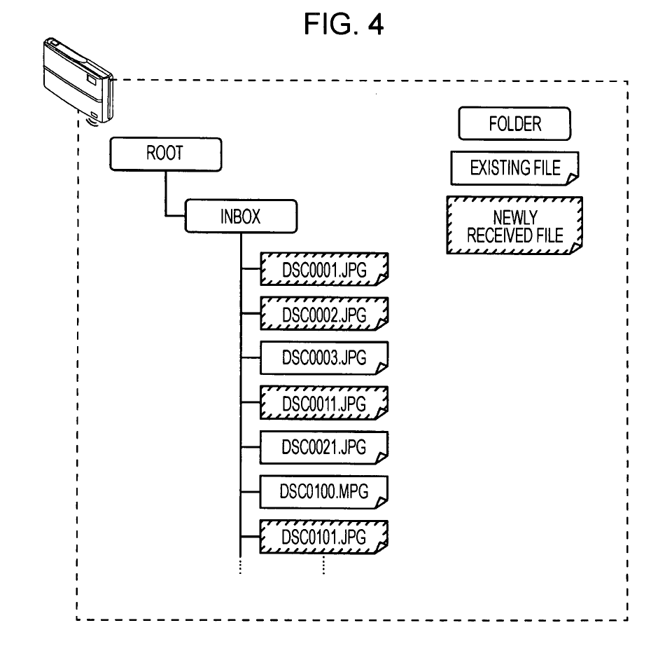

FIG. 4 illustrates a second technique for receiving a group of data files. In this case, the folder configuration on a transmission side before data file transfer is similar to that of the example of FIG. 3.

In the second technique, the hierarchical folder configuration as depicted on the left side of FIG. 3 is disregarded, and all data files are flatly recorded in a recording medium on a reception side. That is, for example, in a folder “INBOX” under a root, data files “DSC0001.JPG”, “DSC0002.JPG”, “DSC0011.JPG”, and “DSC0101.JPG” are recorded.

In this case, since no new folder is created on the reception side, a decrease in performance does not occur. However, since all data files are recorded as being mixed in the same folder with the existing data files, it is difficult for the user to easily recognize which data file has been newly received. For example, in the example of FIG. 4, in addition to the newly received data files, data files “DSC0003.JPG”, “DSC0021.JPG”, and “DSC0100.MPG” are recorded in the recording medium. Unless the user refers to attribute information of these files, such as file updating date, it is difficult for the user to recognize which data file has been newly received, and data file management becomes difficult.

Furthermore, in the short-range wireless communication technology in which a communication connection is automatically established when devices are brought close to each other, the chances of cutting the communication connection due to movement of any of the devices during data transfer are not slim. In such cases, if it is not easy to recognize which data file has been successfully received or has failed to be received, the convenience for users decreases.

To get around this, with the configuration of the receiving device 100 described in detail in the next section, a novel technique is provided for mitigating a decrease in performance at the time of transmission and reception of data files while ease of data file management is kept at a predetermined level in the short-range wireless communication system.

### 2. Example of the Configuration of a Receiving Device According to the Embodiment

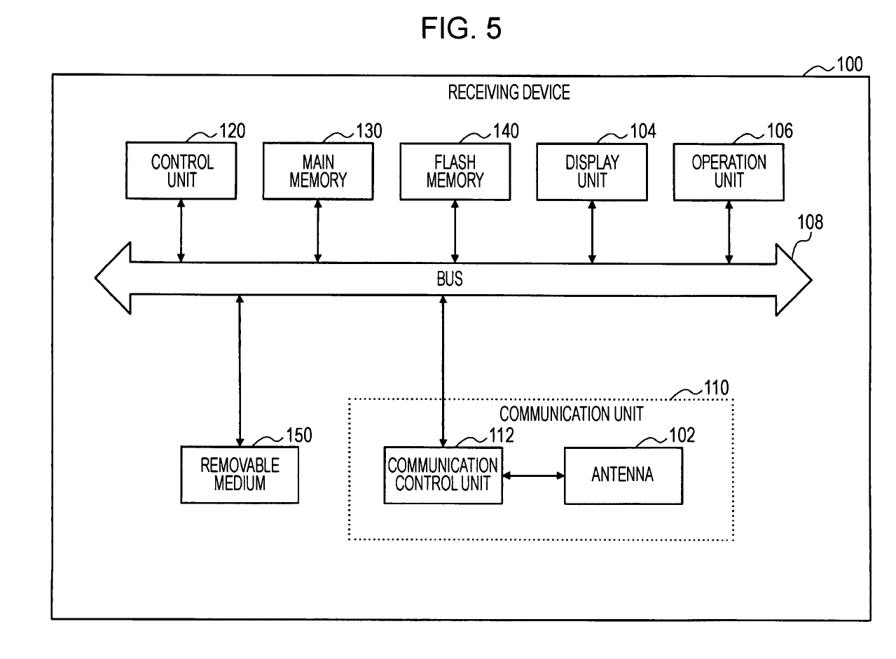

FIG. 5 is a block diagram of an example of configuration of the receiving device 100 according to the embodiment of the present invention. With reference to FIG. 5, the receiving device 100 has the display unit 104, the operation unit 106, a bus 108, a communication unit 110, a control unit 120, a main memory 130, a flash memory 140, and a removable medium 150. The bus 108 connects the display unit 104, the operation unit 106, the communication unit 110, the control unit 120, the main memory 130, the flash memory 140, and the removable medium 150 to each other.

### 2-1. Description of Each Unit

The communication unit 110 operates, according to a short-range wireless communication technique, as an interface that intermediates for a communication connection between the receiving device 100 and another device. As depicted in FIG. 5, the communication unit 110 includes the antenna 102 and a communication control unit 112. For example, the communication control unit 112 periodically transmits a connection request via the antenna 102, and performs an authentication process with a device returning a response. When this authentication process is successful, a communication connection with that device is established. Also, for example, when receiving a connection request from another device via the antenna 102, the communication control unit 112 transmits a response to that connection request. Via the communication connection established as described above, the communication unit 110 receives a group of data files including at least one data file from the transmitting device 200 depicted in FIG. 1, which will be further described below. Here, in place of being incorporated in the receiving device 100, the communication unit 110 may be connected to the receiving device 100 as an external-type communication interface.

The control unit 120 uses a processor, such as a central processing unit (CPU), to control all over the functions of the receiving device 100. In particular, in the present embodiment, the control unit 120 controls recording of data files received by the communication unit 110 in a recording medium. More specifically, the control unit 120 first creates one data recording folder for one communication connection in a predetermined reception folder provided in the recording medium. Then, in the created data recording folder, the control unit 120 records data files received via the communication connection corresponding to the data recording folder. At this time, irrespectively of a file path of each data file before transfer, the control unit 120 records the received data files immediately below the data recording folder. Furthermore, at the time of recording each data file, the control unit 120 changes (renames) a file name of each data file according to a predetermined naming convention. Here, in the present embodiment, data files are transferred by using an arbitrary protocol, such as object exchange (OBEX), file transfer protocol (FTP), or hypertext transfer protocol (HTTP).

Still further, in the data recording folder, the control unit 120 records a management file in which attribute information regarding each data file is stored. In the management file, for example, a file path of each data file before transfer in a transmission-source device of that data file, a data size of each data file, and others are stored as attribute information of the data file. For example, the management file may be a file of an arbitrary type, such as extensible markup language (XML) or comma-separated values (CSV).

The naming convention for a folder name and a file name used by the control unit 120 during recording in the recording medium of the receiving device 100 may be as follows, for example.
Reception folder name: “INBOX”
   This folder is provided in advance in the recording medium.
Data recording folder name: “9999X”
   Upper four digits: a serial number counted up for each communication connection.
   Lower N digits: an arbitrary character string freely set by the user.
Data file name: “RCV99999.EXT”
   Upper three digits: an arbitrary character string freely set by the user.
   Lower five digits: a serial number counted up for each file in the data recording folder.
   Extension: an extension before transfer. However, if the receiving device 100 is not capable of handling the extension before transfer, a fixed value “RCV” is used.
Management file name: “99991NDX.CTL”
   Upper four digits: a number identical to the serial number of the corresponding data recording folder name.
   Lower four digits: a fixed value “INDX”.
   Extension: a fixed value “CTL”.

The naming convention described here is merely an example. That is, within a purpose of the present invention, as long as there is no folder name redundancy and file name redundancy in the same folder, a length or character string of the file name different from that of the above naming convention may be used.

The main memory 130 is a recording medium accessible from the control unit 120, such as a random access memory (RAM). Into the main memory, for example, a program to be executed by the control unit 120 is read at the time of execution.

The flash memory 140 is a recording medium usable for recording a data file received by the communication unit 110. The control unit 120 can record the group of data files received by the communication unit 110 in the flash memory 140 under a folder configuration, which will be described further below. Also, in the flash memory 140, programs for a data file receiving process and other processes executed by the control unit 120 are stored in advance.

The removable medium 150 is also a recording medium usable for recording a data file received by the communication unit 110. The removable medium 150 can be removed from the receiving device 100. When the communication unit 110 is a communication interface externally provided to the receiving device 100, the removable medium 150 may be incorporated in the communication unit 110. The control unit 120 can record the group of data files received by the communication unit 110 in the removable medium 150 under the folder configuration, which will be described further below.

### 2-2. Example of a Folder Configuration According to the Embodiment

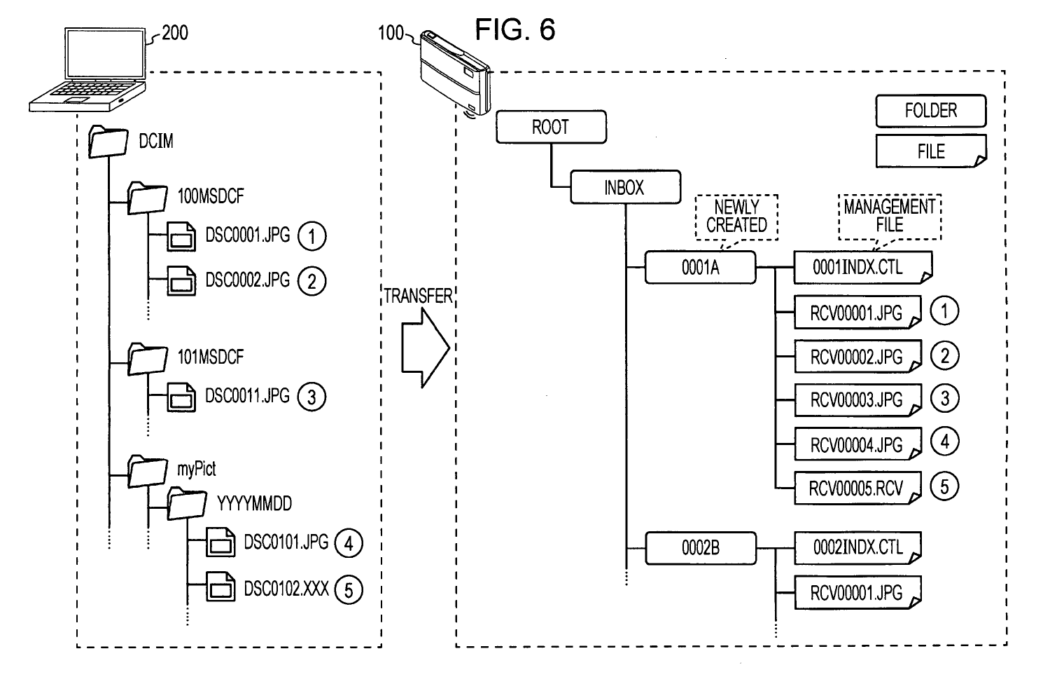

FIG. 6 illustrates an example of arrangement of received data files in the receiving device 100 according to the present embodiment.

On a left side of FIG. 6, a folder configuration of data files in the transmitting device 200 before data file transfer is depicted. For example, under a folder “DCIM”, three folders “100MSDCF”, “101MSDCF”, and “myPict” are present. Among these folders, in the folder “100MSDCF”, data files “DSC0001.JPG” and “DSC0002.JPG” are recorded. Also, in the folder “101MSDCF”, a data file “DSC0011.JPG” is recorded. Furthermore, in the folder “myPict”, a folder “YYYYMMDD” is present. In the folder “YYYYMMDD”, the data files “DSC0101.JPG” and “DSC0102.XXX” are recorded. Among these files, data files with circled numbers 1 to 5 “DSC0001.JPG”, “DSC0002.JPG”, “DSC0011.JPG”, “DSC0101.JPG” and “DSC0102.XXX” are assumed to be specified as targets for data transfer.

On a right side of FIG. 6, a folder configuration of data files in the receiving device 100 after transfer of the data files is depicted. For example, in a folder “INBOX” under a root, a data recording folder “0001A” is created. And, in the folder “0001A”, a data file “RCV00001.JPG”, “RCV00002.JPG”, “RCV00003.JPG”, “RCV00004.JPG”, and “RCV00005.RCV” are recorded. Also, in the folder “0001A”, a management file “00011NDX.CTL” is generated. Here, a folder “0002B” depicted under the data recording folder “0001A” is a data recording folder that can be newly created when a group of data files is further transferred via another communication connection.

As can be understood from FIG. 6, in the present embodiment, five files as targets for data transfer are recorded in one data recording folder “0001A” created in the predetermined reception folder “INBOX”. This data recording folder “0001A” is one folder for one communication connection. Therefore, by referring to a list of files in the data recording folder “0001A”, the user can easily recognize which data file has been successfully received or has failed to be received. Also, since only one data recording folder “0001A” is newly created for one communication connection, even when the number of folders included in the folder configuration in the transmitting device 200 is large, it does not take long hours to create a folder. Therefore, a decrease in performance of the receiving device 100 associated with data transfer is suppressed. Further, the data files are uniformly recorded immediately below the data recording folder “0001A”. Therefore, even when the depth of the folder hierarchy that can be handled by the receiving device 100 is restricted, the folder configuration described above can be adopted.

Still further, each data file is changed according to the naming convention as one example described above so as to be unique in the data recording folder “0001A”. As a result, for example, the receiving device 100 can make the length of the file name of each data file uniform. With this, data files can be easily handled in the receiving device 100 in a manner such that, for example, error handling for a violation of a rule regarding the length of a file name does not occur. Still further, for example, an extension the receiving device 100 is not capable of handling (for example, an extension of a file of an unknown type or an extension with four or more characters) can be changed to another extension. Therefore, any data file can be recorded without being rejected for reception. In the example of FIG. 6, the extension of the data file “DSC0102.XXX” in the transmitting device 200 is changed to “RCV” (“RCV00005.RCV”) in the receiving device 100.

A correspondence between the folder configuration and file names before data transfer and those after data transfer is recognized by referring to the management file, which will be described next.

### 2-3. Example of a Management File According to the Embodiment

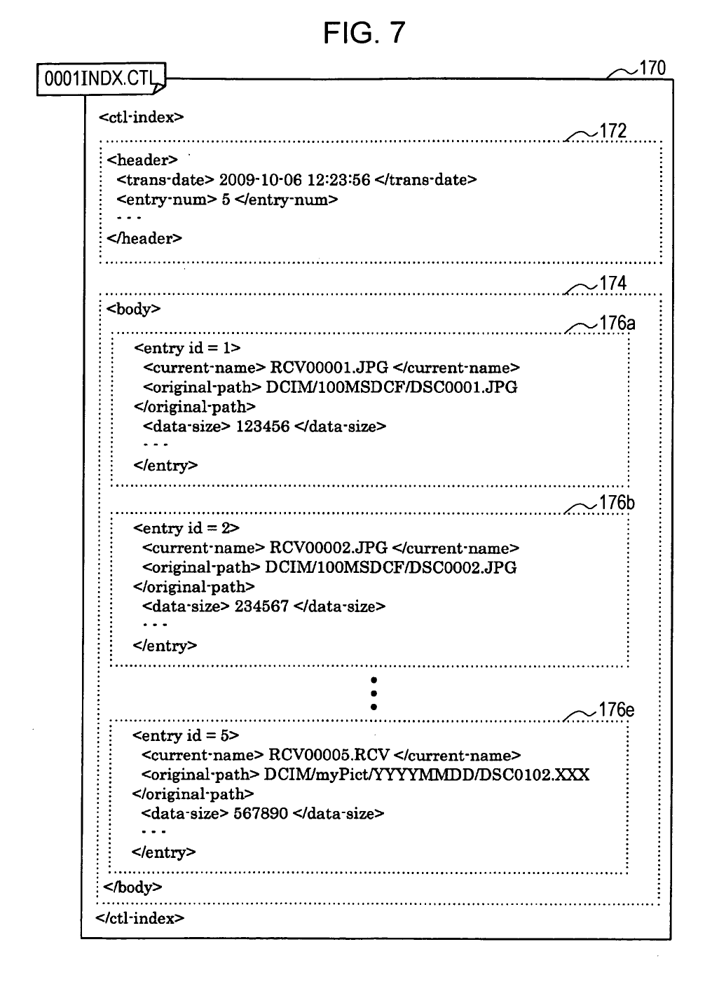

FIG. 7 illustrates an example of a management file recorded in the receiving device 100 according to the present embodiment. With reference to FIG. 7, the management file (“00011NDX.CTL”) includes a header portion 172 and a body portion 174.

In the header portion 172, information common to the group of data files recorded in the same data recording folder as that of the management file is stored. In the example of FIG. 7, a data transfer date and time “trans-date” and a number of entries “entry-num” are stored in the header portion 172. The data transfer date and time represents a date and time when the data file transfer started. The number of entries represents the number of entries included in the body portion 174. The number of entries included in the body portion 174 is equal to the number of data files recorded in the data recording folder.

In the body portion 174, attribute information for each data file recorded in the same data recording folder as that of the management file is stored as an individual entry.

In the example of FIG. 7, five entries 176a to 176e with entry IDs “entry id” of 1 to 5 are recorded in the body portion 174. Also, in each entry, as attribute information for each data file, a file name after transfer “current-name”, a file path before transfer “original-path”, and a data size “data-size” are stored. For example, a file name of the first entry 176a after transfer is “RCV0001.JPG”, a file path before transfer is “DCIM/100MSDCF/DSC0001.JPG”, and a data size is “123456” (kbytes). Also, a file name of the second entry 176b after transfer is “RCV0002.JPG”, a file path before transfer is “DCIM/100MSDCF/DSC0002.JPG”, and a data size is “234567” (kbytes). Further, a file name of the fifth entry 176e after transfer is “RCV00005.RCV”, a file path before transfer is “DCIM/myPict/YYYYMMDD/DSC0102.XXX”, and a data size is “567890” (kbytes).

By referring to this management file, the user can know the correspondence between the folder configuration and file names before data transfer and those after transfer. Also, as will be described in the next section, a device to reconstruct the folder configuration before data transfer and to record each data file can arrange the data files according to their file paths and file names before transfer based on the attribute information included in the management file.

### 2-4. Reconstruction of the Folder Configuration

For example, it is assumed that the user exports data files recorded in the receiving device 100 to an external device and arranges the data files according to the original file paths in a recording medium of the external device. The external device may be a device of an arbitrary type, such as a PC having a short-range wireless communication function. In this case, with the receiving device 100 being placed by the user near the external device, a communication connection via the communication unit 110 is established according the short-range wireless communication technique. The control unit 120 then outputs to the external device the management file together with the data files in the specified data recording folder. The external device recognizes the original file paths and file names of the received data files from “current-name” and “original-path” of each entry in the management file. The external device then renames each received data file to the original file name, and arranges the files on the original file paths.

Here, when the depth of the folder hierarchy that can be handled by the receiving device 100 is not restricted, the receiving device 100 itself may rearrange (or import) each data file according to the file path and file name before transfer. For example, the control unit 120 of the receiving device 100 sequentially records the data files received by the communication unit 110 in the recording medium according to the folder configuration described by using FIG. 6. Upon completion of recording of these data files, the control unit 120 refers to the management file and, based on the attribute information included in the management file, rearranges the data files according to the file paths and file names before transfer. With this, a decrease in performance of data transfer via short-range wireless communication can be mitigated, and data transfer can be completed early. Also, the folder configuration before data transfer can be reconstructed in the receiving device 100.

### 3. Flow of Data File Receiving Process According to the Embodiment

Next, examples along two scenarios are described regarding a flow of a data file receiving process by the receiving device 100 according to the present embodiment. In a first scenario, it is assumed that the transmitting device 200 has a function of generating a management file. On the other hand, in a second scenario, it is assumed that the transmitting device 200 does not have a function of generating a management file.

### 3-1. First Scenario

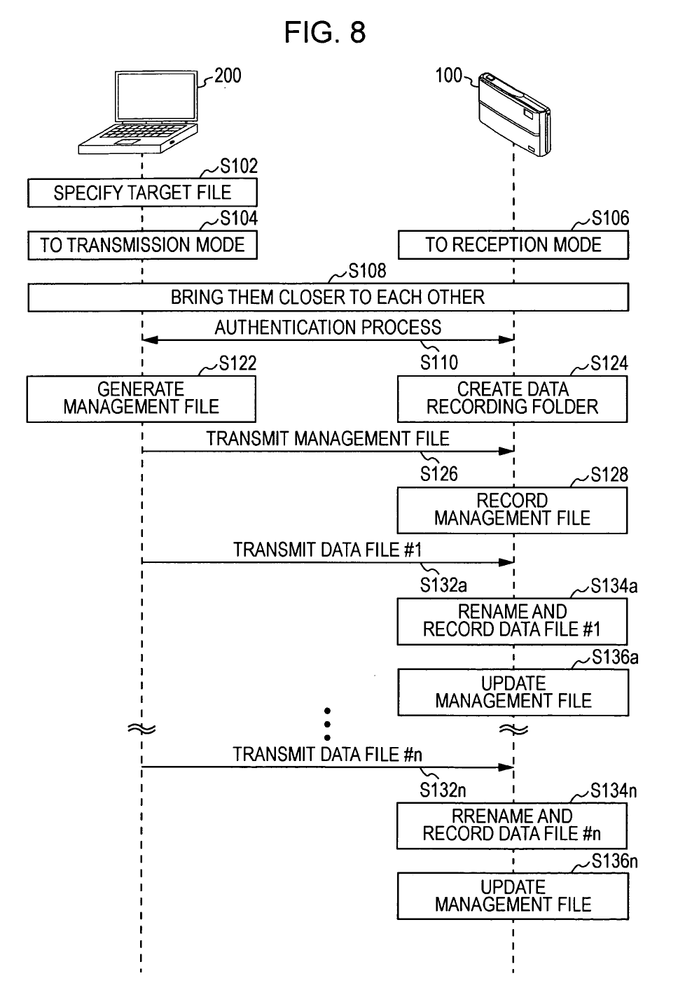

FIG. 8 is a flowchart of an example of a flow of a data file receiving process along the first scenario.

First, in the transmitting device 200, a group of data files as targets for data transfer is specified by the user (step S102). Next, with a predetermined operation by the user, the state of the transmitting device 200 is switched to a transmission mode of short-range wireless communication (step S104). Similarly, the state of the receiving device 100 is switched to a reception mode of short-range wireless communication (step S106). Here, the transmission mode is a mode of periodically transmitting a connection request to a peripheral device to establish a communication connection. On the other hand, the reception mode is a mode of waiting for a connection request from a peripheral device and returning a reply when a connection request is detected, thereby establishing a communication connection. Then, by the user, the transmitting device 200 and the receiving device 100 are brought to closer to each other within a distance allowing short-range wireless communication (step S108). With this, an authentication process is performed between the transmitting device 200 and the receiving device 100 to establish a communication connection (step S110).

When a communication connection is established between the transmitting device 200 and the receiving device 100, the transmitting device 200 generates a management file for the specified group of data files (step S122). Here, in the management file at this moment, a value of the file name of each data file after transfer “current-name” may not be stored. On the other hand, the receiving device 100 creates one data recording folder in a predetermined reception folder provided in the recording medium (step S124). The transmitting device 200 then transmits the generated management file to the receiving device 100 (step S126). The receiving device 100 records the management file received from the transmitting device 200 in the created data recording folder (step S128).

Next, the transmitting device 200 transmits the first data file (#1) among the specified group of data files to the receiving device 100 (step S132a). The receiving device 100 renames the first data file (#1) received from the transmitting device 200 according to the naming convention described above, and then records the data file in the data recording folder (step S134a). The receiving device 100 then adds attribute information, such as the file name of the first data file (#1) after transfer, to the body portion of the management file, thereby updating the management file (step S136a). These processes for each data file are repeated for each specified data file (step S132a to step S136n). Then, upon completion of updating of the management file for the last data file, the data file receiving process along the first scenario completes.

### 3-2. Second Scenario

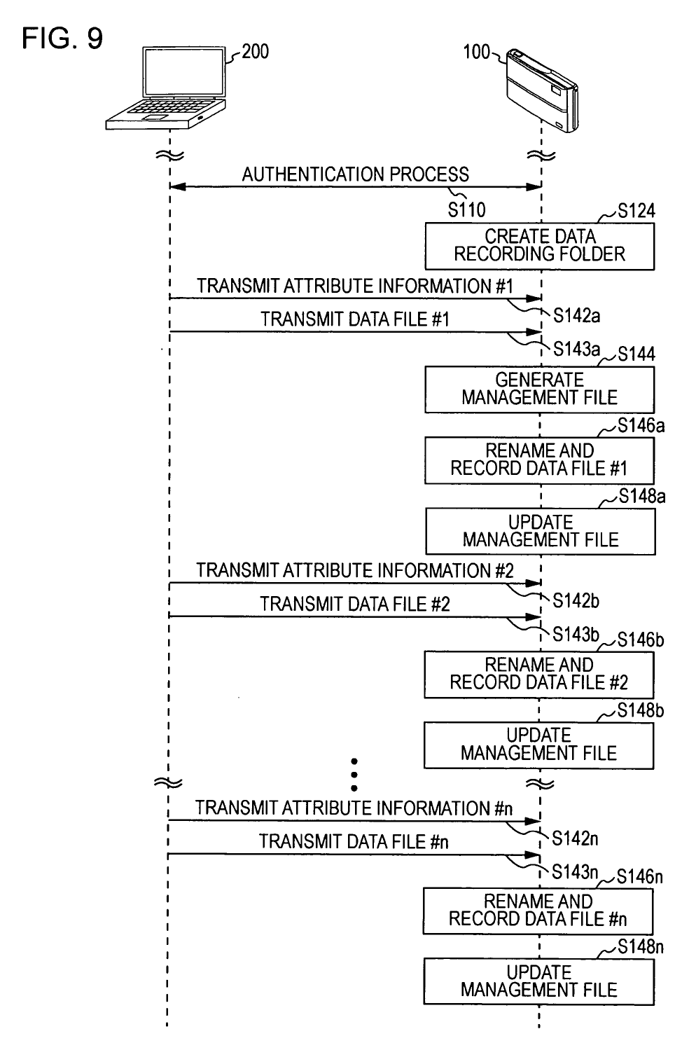

FIG. 9 is a flowchart of an example of a flow of a data file receiving process along the second scenario. Here, the processes until the transmitting device 200 and the receiving device 100 are brought closer to each other (steps S102 to S108) are similar to those in the first scenario. Therefore, these processes are not redundantly described.

First, an authentication process is performed between the transmitting device 200 and the receiving device 100. Upon establishment of a communication connection (step S110), the receiving device 100 creates one data recording folder in a predetermined reception folder provided in a recording medium (step S124).

Next, the transmitting device 200 transmits attribute information about a first data file (#1) among a specified group of data files to the receiving device 100 (step S142a). Here, the attribute information to be transmitted can include a file path, a file name, and a data size of the first data file in the transmitting device 200. Also, the transmitting device 200 transmits the first data file (#1) to the receiving device 100 (step S143a).

Upon receiving the first data file (#1) from the transmitting device 200, the receiving device 100 generates a management file in the data recording folder (step S144). In the management file at this moment, no entry corresponding to each data file is stored. Here, a management file may be generated before the first data file is received. Next, the receiving device 100 renames the first data file (#1) received from the transmitting device 200 according to the naming convention described above, and then records the data file in the data recording folder (step S146a). The receiving device 100 then adds an entry corresponding to the first data file (#1) in a body portion of the management file, thereby updating the management file (step S148a).

Next, the transmitting device 200 transmits attribute information about a second data file (#2) among the specified group of data files to the receiving device 100 (step S142b). Also, the transmitting device 200 transmits the second data file (#2) to the receiving device 100 (step S143b). After that, the receiving device 100 renames the second data file (#2) received from the transmitting device 200 according to the naming convention described above, and then records the data file in the data recording folder (step S146b). The receiving device 100 then adds an entry corresponding to the second data file (#2) to the body portion of the management file, thereby updating the management file (step S148b). These processes for each data file are repeated for each specified data file (step S142a to step S148n). Then, upon completion of updating of the management file for the last data file, the data file receiving process along the second scenario completes.

### 4. Conclusion

In the foregoing, by using FIG. 1 to FIG. 9, the receiving device 100 according to the embodiment of the present embodiment has been mainly described. According to the present embodiment, since only one data recording folder is newly created for one communication connection, a decrease in performance due to a folder creating process at the time of data transfer is mitigated. Also, since data files are uniformly recorded immediately below one data recording folder for each communication connection, the embodiment of the present invention is applicable to a device in which the depth of the folder hierarchy is restricted. Furthermore, the user can easily recognize which data file was transferred when, or which data file has been successfully transferred or has failed to be transferred. Still further, since the file name of each data file is changed according to a predetermined naming convention, recording of the data file is not rejected on the grounds of a violation of regulations on the file name or the extension. Therefore, a loss of an opportunity of transferring a data file can be avoided. Still further, since the data file receiving process and the folder configuration and naming convention on the reception side described in this specification do not depend on the type of data file, a data file of an unknown type can be easily handled.

Here, in this specification, the example is described in which the control unit 120 of the receiving device 100 controls the data file receiving process described by using FIG. 8 or FIG. 9. However, the communication control unit 112 of the communication unit 110 of the receiving device 100 may control the data file receiving process. Even in this case, the advantages of the embodiment of the present invention described above can be enjoyed.

The present application contains subject matter related to that disclosed in Japanese Priority Patent Application JP 2009-289460 filed in the Japan Patent Office on Dec. 21, 2009, the entire contents of which are hereby incorporated by reference.

In the foregoing, while the preferred embodiments of the present invention have been described in detail with reference to the attached drawings, embodiments of the present invention are not restricted to these preferred embodiments.

It is obvious that various modified examples and corrected examples can be thought by those skilled in the art within the scope of the technical idea according to the embodiments of the present invention, and these examples can be understood as duly pertaining to the technical scope of the present invention.

What is claimed is:

1. A receiving device comprising:
a communication unit receiving at least one data file from another device via a communication connection; and
a control unit controlling recording of the data file received from the communication unit in a recording medium; wherein
the control unit creates one data recording folder for one communication connection in a predetermined reception folder provided in the recording medium and records, in the created data recording folder, the data file received via the communication connection corresponding to the data recording folder and a management file in which attribute information regarding each data file is stored.

2. The receiving device according to claim 1, wherein the control unit records the data file immediately below the data recording folder irrespectively of a file path of each data file before transfer.

3. The receiving device according to claim 2, wherein the control unit changes a file name of each data file according to a predetermined rule, and then records each data file in the data recording folder.

4. The receiving device according to claim 3, wherein the control unit stores, in the management file, a file path of each data file in the other device before transfer as the attribute information of the data file.

5. The receiving device according to claim 4, wherein the control unit outputs the management file together with the data file to a device in which the data file recorded in the data recording folder is to be arranged according to the file path before transfer.

6. The receiving device according to any one of claims 1 to 5, wherein the recording medium is a recording medium having a predetermined restriction on a depth of a hierarchy of creatable folders.

7. The receiving device according to any one of claims 1 to 6, wherein the communication connection is a communication connection established according to a short-range wireless communication technique.

8. A data file recording method in a receiving device receiving at least one data file from another device via a communication connection, the method comprising the steps of:
establishing the communication connection with the other device;
creating one data recording folder for one communication connection in a predetermined reception folder provided in the recording medium; and
recording, in the created data recording folder, the data file received via the communication connection corresponding to the data recording folder, and a management file in which attribute information regarding each data file is stored.

9. A program causing a computer controlling a receiving device receiving at least one data file from another device via a communication connection to function as a control unit controlling recording of the received data file in a recording medium, wherein
the control unit creates one data recording folder for one communication connection in a predetermined reception folder provided in the recording medium and records, in the created data recording folder the data file received via the communication connection corresponding to the data recording folder and a management file in which attribute information regarding each data file is stored.
